(19) United States
(12) Patent Application Publication
(10) Pub. No.: US 2007/0233575 A1
(43) Pub. Date: Oct. 4, 2007

(54) Architectural design for strategic sourcing application software

(76) Inventors: Arthur Berger, Heppenheim (DE); Bettina Jaeger, Heidelberg (DE); Peter Fitz, Waldsee (DE); Karin Brecht-Tillinger, Edingen-Neckarhausen (DE); Arnulf Schueler, Heidelberg (DE); Paola Sala, Heidelberg (DE); Armin Schwarz, Gaiberg (DE); Peter J. Neumayer, Edenkoben (DE); Otfried Von Geisau, Sinshein (DE); Matthias Tebbe, Walldorf (DE); Jens Freund, Heidelberg (DE)

Correspondence Address: FISH & RICHARDSON, P.C., PO BOX 1022, MINNEAPOLIS, MN, 55440-1022, US

(21) Appl. No.: 11/396,312

(22) Filed: Mar. 30, 2006

(51) Int. Cl. G06Q 30/00

(52) U.S. Cl. 705/26

(57) ABSTRACT

Methods, systems, and apparatus, including computer program products, for implementing a software architecture design for a software application implementing strategic sourcing. The application is structured as multiple process components interacting with each other through service interfaces, and multiple service operations, each being implemented for a respective process component. The process components include a Purchasing Contract Processing process component, a Supplier Invoicing process component, a Product Catalog Authoring process component, and a Source of Supply Determination process component.

### BACKGROUND

The subject matter of this patent application relates to computer software architecture, and more particularly to the architecture of application software for strategic sourcing.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification describes a software architecture design for a software application implementing strategic sourcing.

The invention can be implemented as methods, systems, and apparatus, including computer program products, implementing a software architecture design for a software application implementing strategic sourcing. The application is structured as multiple process components interacting with each other through service operations, each being implemented for a respective process component. The process components include a Purchasing Contract Processing process component, a Supplier Invoice Processing process component, a Product Catalog Authoring process component, and a Source of Supply Determination process component.

The invention can further be implemented as methods, systems, and apparatus, including computer program products, implementing a software architecture design for a software application that is adapted to interact with external software systems through the service operations described in reference to external process components, or a subcombination of them.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a strategic sourcing software application.

FIG. 2 illustrates the elements of the architecture as they are drawn in the figures of this patent application.

FIG. 3 is a block diagram showing interactions between a Purchase Contract Processing process component and a Product Catalog Authoring Processing process component.

FIG. 4 is a block diagram showing interactions between a Purchasing Contract Processing process component and a Supplier Invoice Processing process component.

FIG. 5 is a block diagram showing interactions between an RFQ Processing process component and an Opportunity/Customer Quote Processing at Supplier process component.

FIGS. 6A-6B are block diagrams collectively showing interactions between an RFQ Processing process component and a Purchasing Contract Processing process component.

### DETAILED DESCRIPTION

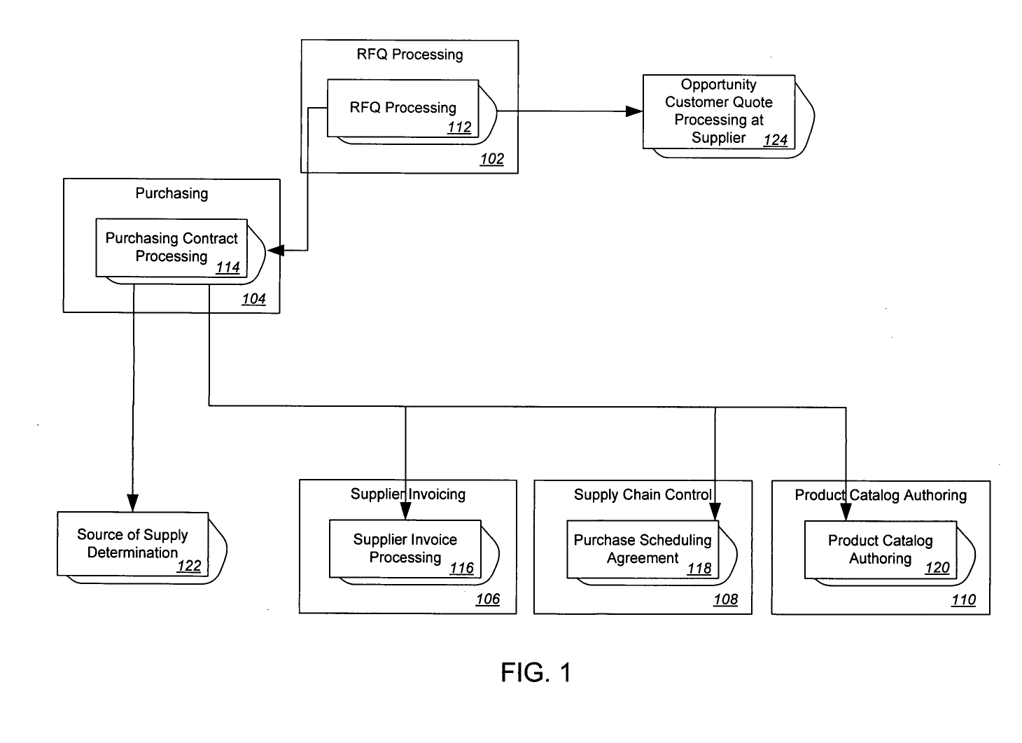

FIG. 1 shows the software architectural design for a strategic sourcing software application. The strategic sourcing software application is software to find new suppliers and create purchasing contracts with them. Sourcing is a main task of a strategic purchaser.

As shown in FIG. 1, the strategic sourcing design includes five deployment units: an optional RFQ Processing deployment unit 102, a Purchasing deployment unit 104, a Supplier Invoicing deployment unit 106, and a Catalog Authoring deployment unit 110.

The RFQ Processing deployment unit 102 includes an optional RFQ Processing process component 112. The optional RFQ Processing process component 112 describes materials and services that purchasers use to request responses from potential suppliers. Requests for quotation can be one of the following types: a request for information (e.g., price information), a request for quote (RFQ) that may run over a certain period of time, a request for proposal (RFP) in complex purchasing scenarios, or live auctions that are normally performed over a short time frame. A quote is a response to a request for quotation in which a supplier offers to sell goods and services at a certain price. A quote can be subject to complex pricing and conditions.

The Purchasing deployment unit 104 includes a Purchasing Contract Processing process component 114. The Purchasing Contract Processing process component 114 includes a Purchasing Contract business object, which can be an agreement between a purchaser and a supplier. The Purchasing Contract business object may cover the supply of goods or the performance of services at agreed conditions.

The Supplier Invoicing deployment unit 106 includes a Supplier Invoicing process component 116. The Supplier Invoicing process component 116 includes a Supplier Invoice and a Supplier Invoice Request business objects. The Supplier Invoice is a document that states the recipient's (usually the purchaser's) obligation to pay the supplier for goods received or services rendered. An invoice is normally created after the goods and service acknowledgment has been confirmed. The Supplier Invoice Request is a document that is sent to invoice verification, advising that an invoice for specified quantities and prices is expected or to be created through evaluation settlement. The system uses the invoice request as a basis for invoice verification, as well as for the automatic creation of the invoice.

The Catalog Authoring deployment unit 110 includes a Product Catalog Authoring process component 120. The Product Catalog Authoring process component 120 is used to create and edit Product Catalogs by collecting product information from the relevant sources, to control the quality of the Product Catalogs' contents, and to determine when Product Catalogs can be published for use in other business processes. Sources of product information can be external, such as Product Catalogs sent by the product suppliers, or internal product master data.

The strategic sourcing design also includes a Source of Supply Determination process component. The Source of Supply Determination process component enables maintenance of and access to sources of supply and quota arrangements for external and internal procurement processes.

An Opportunity Customer Quote Processing at Supplier process component 124 will be used to describe the architectural design. The Opportunity Customer Quote Processing at Supplier process component 124 is an external process component external to the design. The Opportunity Customer Quote Processing at Supplier process component 124 will be described below in detail.

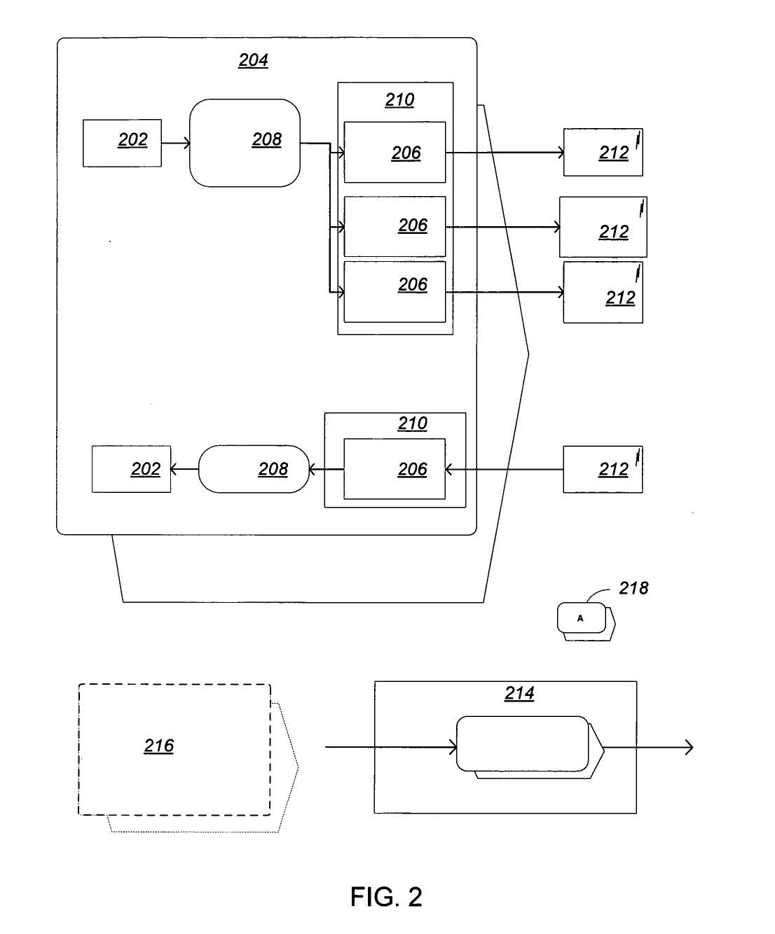

FIG. 2 illustrates the elements of the architecture as they are drawn in the figures of this patent application. The elements of the architecture include the business object (drawn as icon 202), the process component (drawn as icon 204), the service operation or operation (drawn as icon 206), the process agent (drawn as icon 208), the service interface or interface (drawn as icon 210), the message (drawn as icon 212), and the deployment unit (drawn as icon 214).

Not explicitly represented in the figures is a foundation layer that contains all fundamental entities that are used in multiple deployment units. These entities can be process components, business objects or reuse service components. A reuse service component is a piece of software that is reused in different transactions. A reuse service component is used by its defined interfaces, which can be, e.g., local APIs (Application Programming Interfaces) or service interfaces.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are assigned to their respective deployment unit.

A process component of an external system is drawn as a dashed-line process component (drawn as icon 216). Such a process component may be referred to as an external process component, and it is used to represent the external system in describing interactions with the external system; however, this should be understood to require no more of the external system that it be able to produce and receive messages as required by the process component that interacts with the external system.

The connector icon 218 is used to simplify the drawing of interactions between process components.

Interactions between process component pairs involving their respective business objects, process agents, operations, interfaces, and messages are described as process component interactions, which determine the interactions of a pair of process components across a deployment unit boundary, i.e., from one deployment unit to another deployment unit. Interactions between process components are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components, but interfaces, process agents, and business objects that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. A process component is a software package that realizes a business process and generally exposes its functionality as services. The functionality contains business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters serving as a signature.

The architectural elements also include the service interface, referred to simply as the interface. An interface is a named group of operations. Each operation belongs to exactly one interface. An interface belongs to exactly one process component. A process component might contain multiple interfaces. In one implementation, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An output process agent will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement supports the operations of the original.

Process Component Interaction Model “Purchase Contract Processing” and “Product Catalog Authoring”

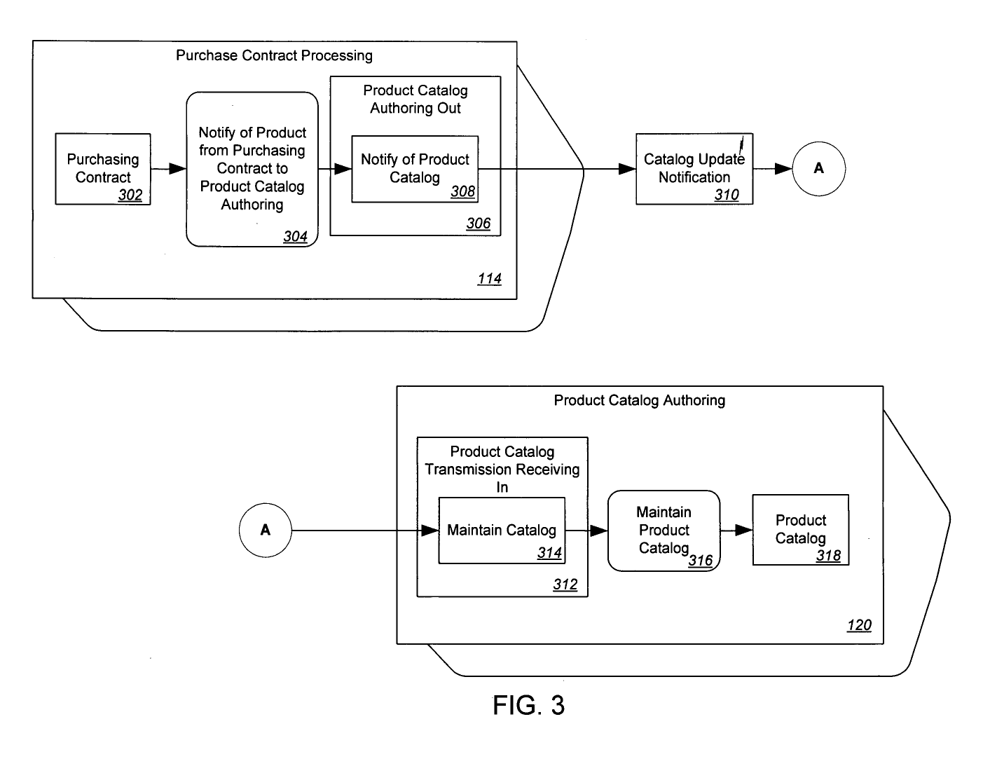

FIG. 3 is a block diagram showing interactions between a Purchase Contract Processing process component 114 and a Product Catalog Authoring process component 120 in the architectural design of FIG. 1. The Purchase Contract Processing process component 114 includes a Purchase Contract business object 302. The Purchase Contract business object 302 may be an outline purchase agreement that contains special conditions that are negotiated between a purchaser and a seller, and may cover the supply of goods, or the performance of services at agreed conditions. The Purchase Contract business object 302 passes information that is relevant for Catalog distribution into a Notify of Product from Purchasing Contract to Product Catalog Authoring outbound process agent 304.

The outbound process agent 304 sends notification into a Product Catalog Authoring Out interface 306 which includes a Notify of Product Catalog operation 308. The Notify of Product Catalog operation 308 can create or update items in catalog authoring from a released purchasing contract. A Catalog Update Notification message 310 may then be sent to the Product Catalog Authoring process component 120.

The Product Catalog Authoring process component 120 receives the Catalog Update Notification message 310 in a Product Catalog Transmission Receiving In interface 312 which includes a Maintain Catalog operation 314 that can create a new catalog, or change or delete an existing catalog. The operation 314 may then create, change, or delete a Product Catalog business object 318 using a Maintain Product Catalog inbound process agent 316. The Product Catalog business object 318 is a structured directory of catalog items, where each catalog item represents a product and provides information about it. A Product Catalog serves to provide or exchange information about a subset of a company's products. The information is tailored to a specific target group of people, to provide exactly the information the group of people needs or to advertise the products to the group.

Process Component Interaction Model “Purchase Contract Processing” and “Supplier Invoice Processing”

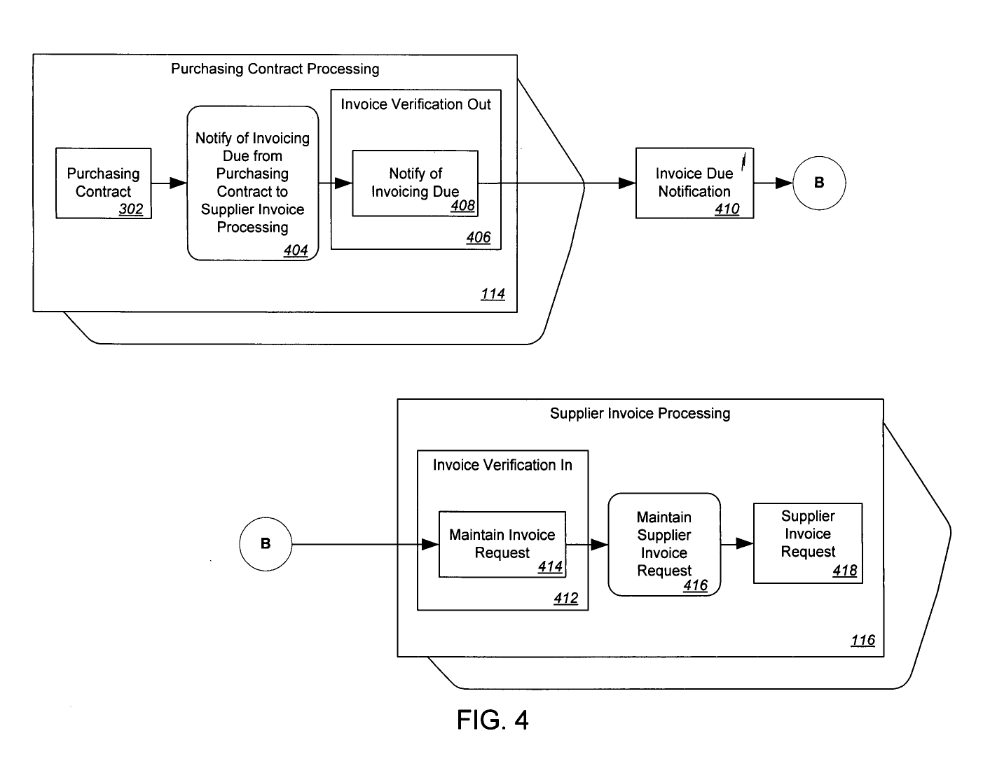

FIG. 4 is a block diagram showing interactions between a Purchase Contract Processing process component 114 and a Supplier Invoice Processing process component 116 in the architectural design of FIG. 1. In this example, the Purchase Contract business object 302 may trigger a Notify of Invoicing Due from purchasing Contract to Supplier Invoice Processing outbound agent 404.

The outbound process agent 404 sends notification into an Invoice Verification Out interface 406, which includes a Notify of Product Catalog operation 408. The Notify of Invoicing Due operation 408 can create a new Supplier Invoicing Request or update an existing Supplier Invoice Request from a released Purchasing Contract. An Invoice Due Notification message 410 may then be sent to the Supplier Invoice Processing process component 116.

The Supplier Invoice Processing process component 116 receives the Invoice Due Notification message 410 in an Invoice Verification In interface 412 which includes a Maintain Invoice Request operation 414 that can create or update a reference object in the Supplier Invoicing deployment unit 106 in order to perform invoice verification with reference to a purchase order. The reference object is used for checks against the preceding documents and to make proposals for invoice entry. The operation 414 may then update a Supplier Invoice Request business object 418 using a Maintain Supplier Invoice Request inbound process agent 416. The Supplier Invoice Request business object 418 is a document that is sent to invoice verification, advising that an invoice for specified quantities and prices is, for example, expected or to be created through evaluation settlement. The system uses the invoice request as a basis for invoice verification, as well as for the automatic creation of the invoice.

Interactions between Process Components “RFQ Processing” and “Opportunity/Customer Quote Processing at Supplier”

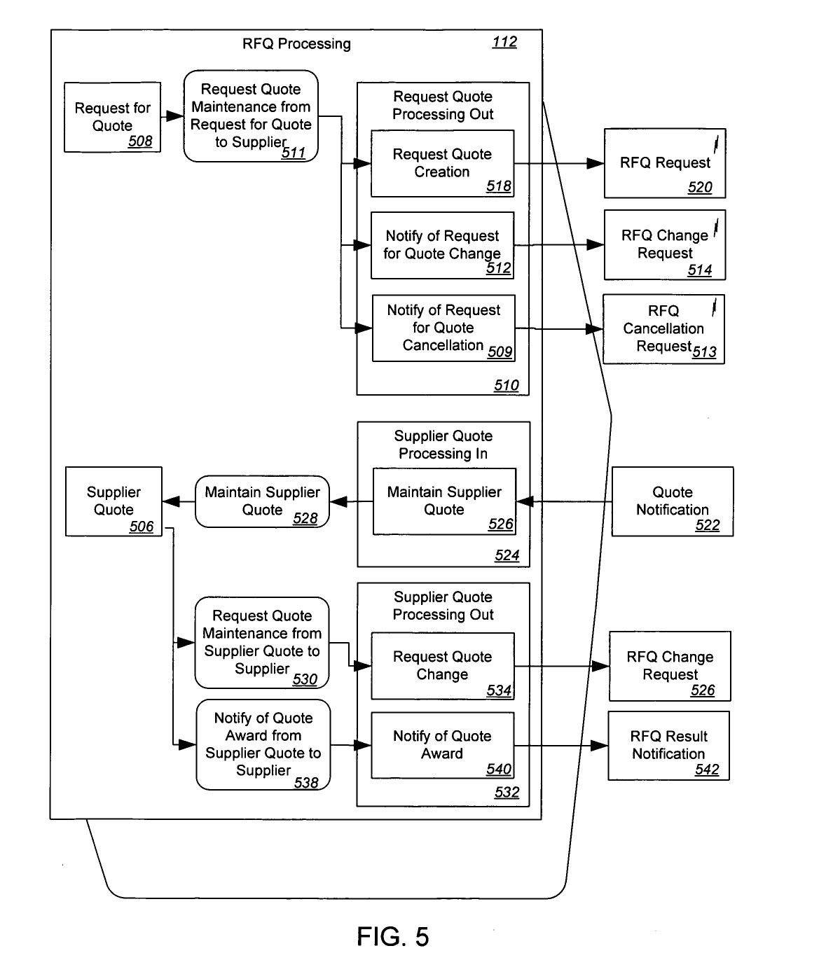

FIG. 5 is a block diagram showing interactions between an RFQ process component 112 and an external process component, such as an Opportunity/Customer Quote Processing at Supplier process component 124 in this example, in the architectural design of FIG. 1.

The RFQ process component 112 includes two business objects. A Supplier Quote business object 506 is a response to a Request for Quote, in which a bidder offers to sell goods and services to a buyer according to the requested criteria. A Request for Quote business object 508 is a request from a buyer to a bidder to submit a quote for a material or a service according to specified criteria.

In this example, a Request Quote Maintenance from Supplier Quote to Supplier outbound process agent 511 invokes a Request Quote Processing Out interface 510 when a Request for Quote has been changed or Supplier Quote is sent back to Supplier.

The Request Quote Processing Out interface 510 includes a Notify of Request for Quote Cancellation operation 509 that sends the changes of a published Request for Quote to a supplier to participate in the further request for quote processes thereby generating a Request for Quote Cancellation Request message 513. The Request Quote Processing Out interface 510 also includes a Notify of Request for Quote Change operation 512 that sends the Request for Quote business object 508 to a supplier to participate in a request for quote processes, generating a Request for Quote Change Request message 514.

Additionally, the Request Quote Processing Out interface 510 includes a Request Quote Creation operation 518 that requests the quote, generating a Request for Quote Request message 520.

A Quote Notification message 522 may be received in the Supplier Quote Processing In interface 524, and in response a Maintain Supplier Quote operation 526 updates the Supplier Quote business object 506 using a Maintain Supplier Quote inbound process agent 528.

The Supplier Quote business object 506 may use a Request Quote Maintenance from Request for Quote to Supplier outbound process agent 530 to update the status of a quote to ‘Accepted’ or ‘Rejected.’ A Supplier Quote Processing Out interface 532 includes a Request Quote Change operation 534, thereby generating an RFQ Change Request message 536.

Alternatively, the Supplier Quote business object 506 may use a Notify of Quote Award from Supplier Quote to Supplier outbound process agent 538 to check whether a request for quote is published, re-published or cancelled. The Notify of Quote Award operation 540 may then send acceptance or final rejection of the quote to the supplier through an RFQ Result Notification message 542.

Process Component Interaction Model “RFQ Processing” and “Purchase Contract Processing”

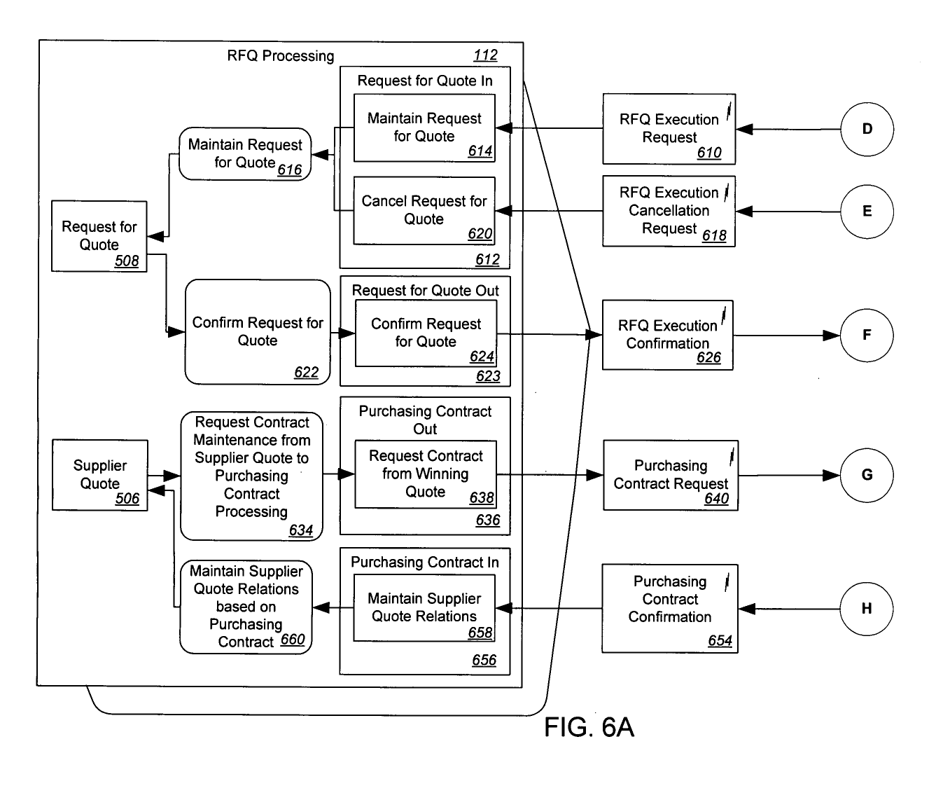

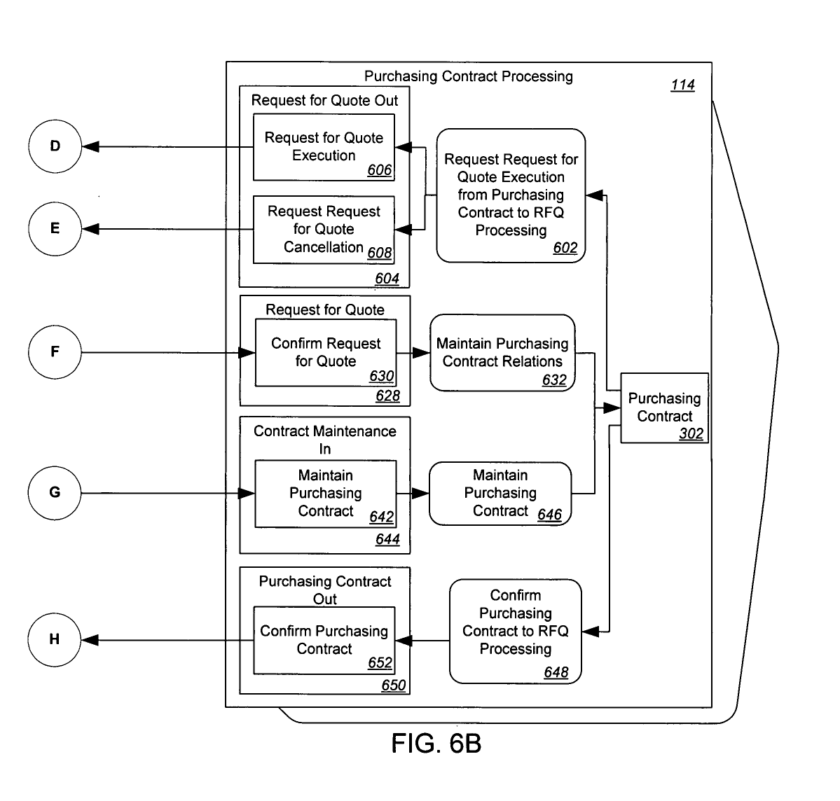

FIGS. 6A and 6B are block diagrams collectively showing interactions between the RFQ Processing process component 112 and the Purchasing Contract Processing process component 114. As shown in FIG. 6B, the Purchasing Contract business object 302 can trigger a Request Request for Quote Execution from Purchasing Contract to RFQ Processing outbound process agent 602. The Request Request for Quote Execution from Purchasing Contract to RFQ Processing outbound process agent 602 then invokes a Request for Quote Execution operation 606 or a Request Request for Quote Cancellation operation 608, both found in a request to a Request for Quote Out interface 604.

If the Request for Quote Execution operation 606 is invoked, the operation 606 can create and send an RFQ Execution Request message 608 (FIG. 6A) to request execution of a Request for Quote. The RFQ Processing process component 112 can receive the RFQ Execution Request message 608 in a Maintain Request for Quote operation 614 included in a Request for Quote In interface 612. The operation 614 is handled by a Maintain Request for Quote inbound process agent 616 that maintains Request for Quote by creating or updating the Request for Quote business object 508 out of business documents that are involved in the bidding process or in the negotiation process.

If the Request Request for Quote Cancellation operation 608 (FIG. 6B) is invoked, then the operation 608 can create and send a RFQ Execution Cancellation Request message 618 (FIG. 6A) to request cancellation of a Request for Quote. The RFQ Processing process component 112 can receive the RFQ Execution Cancellation Request message 618 using a Cancel Request for Quote operation 620 included in the Request for Quote In interface 612. The operation 620 is handled by Maintain a Request for Quote inbound process agent 616 that cancels the Request For Quote and stops the bidding process by canceling the Request for Quote business object 508.

A creation or update of the Request for Quote business object 508 from a negotiation process may trigger a Confirm Request for Quote outbound process agent 622. The Confirm Request for Quote outbound process agent 622 invokes a Confirm Request for Quote operation 624 in a Request for Quote Out interface 623. The operation 624 sends an RFQ Execution Confirmation message 626 to the Purchasing Contract Processing process component 114 that the Request for Quote was created or updated.

The Purchasing Contract Processing process component 114 receives the RFQ Execution Confirmation message 626 in a Request for Quote interface 628, which includes a Confirm Request for Quote operation 630. The Confirm Request for Quote operation 630 receives the confirmation message 626 that the Request for Quote was created from contract negotiation process. The operation 630 then triggers a Maintain Purchasing Contract Relations inbound process agent 632 to update the Purchasing Contract business object 302.

A creation or update of the Supplier Quote business object 506 from a negotiation process may trigger a Request Contract Maintenance from Supplier Quote to Purchasing Contract Processing outbound process agent 634 when a Supplier Quote is accepted. The Request Contract Maintenance from Supplier Quote to Purchasing Contract Processing outbound process agent 634 creates and sends a Purchasing Contract from accepted Supplier Quote to Purchasing Contract Out interface 636, which includes a Request Contract from Winning Quote operation 638. The operation 638 sends a Purchasing Contract Request message 640 to the Purchasing Contract Processing process component 114.

The Purchasing Contract Processing process component 114 receives the Purchasing Contract Request message 640 in a Contract Maintenance In interface 642, which includes a Maintain Purchasing Contract operation 644. The Maintain Purchasing Contract operation 644 creates or updates the Purchasing Contract business object 302 out of business documents that are involved in the strategic purchasing process using a Maintain Purchasing Contract inbound process agent 646.

A creation or update of the Purchasing Contract business object 302 triggers a Confirm Purchasing Contract to RFQ Processing outbound process agent 648. The Confirm Purchasing Contract to RFQ Processing outbound process agent 648 invokes a Confirm Purchasing Contract operation 652, which may be found in a Purchasing Contract Out interface 650. The operation 652 sends a Purchasing Contract Confirmation message 654 notifying that the Purchasing Contract business object 302 was created or updated from the accepted Supplier Quote.

The RFQ Processing process component 112 receives the message 654 in a Purchasing Contract In interface 656, which includes a Maintain Supplier Quote Relations operation 658. The Maintain Supplier Quote Relations operation 658 can be handled by a Maintain Supplier Quote Relations based on Purchasing Contract inbound process agent 660 that can create or update Request for Quote relations from Purchasing Contract and update the Supplier Quote business object 506.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back end component (e.g., a data server), a middleware component (e.g., an application server), or a front end component (e.g., a client computer having a graphical user interface or a Web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
a Purchasing Contract Processing process component that includes a purchasing contract business object;
a Supplier Invoice Processing process component that includes a supplier invoice business object and a supplier invoice request business object;
a Product Catalog Authoring process component that is used to create and edit product catalog; and
a plurality of service operations, each service operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Purchase Contract Processing process component and the Supplier Invoice Processing process component;
the Purchase Contract Processing process component and the Product Catalog Authoring process component.

2. The product of claim 1, wherein
the plurality of process components further includes:
an RFQ Processing process component that handles requests for quotation and corresponding quotes; and wherein
the pair-wise interaction between pairs of the process components further include interaction between:
the RFQ Processing process component and the Purchasing Contract Processing process component.

3. The product of claim 2, wherein:
each of the plurality of process components is assigned to no more than one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

4. The product of claim 3, wherein the deployment units comprise:
a Supplier Invoicing deployment unit that includes the Supplier Invoice Processing process component;
a Request for Quote deployment unit that includes the RFQ Processing process component;
a Purchasing deployment unit that includes the Purchasing Contract Processing process component; and
a Catalog Authoring deployment unit that includes the Product Catalog Authoring process component.

5. The product of claim 1, wherein:
each of the process components includes one or more business objects; and
none of the business objects of any one of the process components interacts directly with any of the business objects included in any of the other process components.

6. The product of claim 5, wherein the business objects comprise a business process object.

7. The product of claim 5, wherein:
none of the business objects included in any one of the process components is included in any of the other process components.

8. The product of claim 1, further comprising:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

9. The product of claim 8, wherein:
the inbound process agents comprise a first inbound process agent operable to start the execution of step requested in a first inbound message by creating or updating one or more business object instances.

10. The product of claim 8, wherein:
the outbound process agents comprise a first asynchronous outbound process agent that is called after a business object that is associated with the first outbound process agent changes.

11. The product of claim 1, wherein the operations comprise synchronous and asynchronous operations.

12. A system, comprising:
a computer system comprising one or more hardware platforms for executing a computer software application;
a plurality of process components, each of the process components being a package of software implementing a respective and distinct business process, the plurality of process components including:
a plurality of process components, each of the process components being a package of software implementing a respective and distinct business process, the plurality of process components including:
a Purchasing Contract Processing process component that includes a purchasing contract business object;
a Supplier Invoice Processing process component that includes a supplier invoice business object and a supplier invoice request business object; and
a Product Catalog Authoring process component that is used to create and edit product catalog.

13. The system of claim 12, wherein:
each of the process components includes one or more business objects; and
none of the business objects of any one of the process components interacts directly with any of the business objects included in any of the other process components.

14. The system of claim 12, wherein:
none of the business objects included in any one of the process components is included in any of the other process components.

15. The system of claim 12, wherein:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

16. The system of claim 12, the system comprising multiple hardware platforms, wherein:
the Supplier Invoice Processing process component is deployed on a first hardware platform;
the Product Catalog Authoring process component is deployed on a second hardware platform; and
the Purchasing Contract Processing process component is deployed on a third hardware platform.

17. The system of claim 16, wherein each of the first through the third hardware platforms are distinct and separate from each other.

18. A method for developing a computer software application, comprising:
obtaining in a computer system digital data representing an architectural design for a set of processes implementing an end-to-end application process, the design specifying a process component for each process in the set of processes, the design specifying further specifying a set of process component interactions, wherein
the specified process components include:
a plurality of process components, each of the process components being a package of software implementing a respective and distinct business process, the plurality of process components including:
a Purchasing Contract Processing process component is deployed on a fourth hardware platform
a Supplier Invoice Processing process component that includes a supplier invoice business object and a supplier invoice request business object;
a Product Catalog Authoring process component that is used to create and edit product catalog; and wherein
the process component interactions include interactions between:
the Purchase Contract Processing process component and the Supplier Invoice Processing process component; and
the Purchase Contract Processing process component and the Product Catalog Authoring process component; and
using the design including the specified process components and the specified process component interactions to develop a computer software application to perform the set of processes.

19. The method of claim 18, wherein:
each process in the set of processes is a business process transforming a defined business input into a defined business outcome.

20. The method of claim 19, wherein:
obtaining digital data representing the architectural design further comprises editing the design before using the design.
